(19) United States
(12) Patent Application Publication
(10) Pub. No.: US 2001/0032949 A1
(43) Pub. Date: Oct. 25, 2001

(54) COUPLING FOR A FLUID DELIVERY PIPE

(76) Inventor: ROD MCCRACKEN, GEEBUNG (AU)

Correspondence Address: BENMAN & COLLINS, 75 WEST CALLE DE LAS TIENDAS, SUITE 125B, GREEN VALLEY, AZ, 85614

(21) Appl. No.: 09/412,967

(22) Filed: Oct. 5, 1999

(30) Foreign Application Priority Data
Jun. 10, 1998 (AU) PP6314

(51) Int. Cl. F16K 51/00

(52) U.S. Cl. 251/128; 251/148; 285/320

(57) ABSTRACT

A coupling for a fluid delivery pipe, the coupling having a housing with an inlet, outlet and interconnecting passage, a valve actuating means including an elongate member which extends to an inlet end of the housing and an external locking means for securing to the coupling the fluid delivery pipe, wherein in use when the coupling is secured to the fluid delivery pipe by the locking means the valve actuating means is operable to force the elongate member into contact with a valve assembly of the fluid delivery pipe to force the valve assembly to open and allow passage of fluid into the inlet and out through the outlet.

The present invention relates to fluid couplings and is particularly relevant to irrigation couplings such as quick couplings or turf valves for golf courses.

In a typical irrigation system two-way valves are commonly used to switch a water supply on and off. Ideally one two-way valve would be provided for each outlet otherwise it would be necessary to have a two-way valve controlling more than one outlet, with the result that all outlets with which it is associated must be turned off whenever it is necessary to fix a hose to one or more of the outlets. The cost of providing a two-way valve is a significant factor in setting up an irrigation system. Furthermore it is common for an outlet to be located some distance from the two-way valve, which leads to obvious problems with quickly coupling and uncoupling a hose to an outlet and turning a water supply on and off.

It follows from the above that it would be desirable to have an outlet which can have a hose attached to it without having to resort to turning a two-way valve on and off in the process.

According to the present invention there is provided a coupling for a fluid delivery pipe, the coupling having a housing with an inlet, outlet and interconnecting passage, a valve actuating means including an elongate member which extends to an inlet end of the housing and an external locking means for securing the coupling to the fluid delivery pipe, wherein in use when the coupling is secured to the fluid delivery pipe by the locking means the valve actuating means is operable to force the elongate member into contact with a valve assembly of the fluid delivery pipe to force the valve assembly to open and allow passage of fluid into the inlet and out through the outlet.

The housing preferably includes a flange portion at its inlet end which flange portion is adapted to abut an outlet flange of the fluid delivery pipe.

The housing inlet end may be adapted to fit inside the outlet end of the fluid delivery pipe.

The housing outlet may extend from a side of a main body of the housing.

The housing may include a tubular main body.

The tubular main body may include an upper end adapted to receive the valve actuating means and a lower end including the inlet. The outlet may extend at right angles to the main body.

The outlet preferably extends from an upper section of the main body.

The valve actuating means may include a tap fitting.

The valve actuating means may include a tap fitting which is threadably engaged in the upper end of the main body.

The elongate member preferably comprises a rod which extends to a region inside the inlet.

The locking means may include a plurality of latches.

The latches may be diametrically opposed on opposite sides of the main body.

The locking means may include lateral members with the latches located at respective ends thereof.

Each latch may include a lever pivotally attached to the lateral member.

Preferably each lever is pivotally attached at a mid section thereof.

Each lever may have one end provided with a detent/catch which is adapted to catch under the outlet flange of the fluid delivery pipe.

The detent may be angled at 85° with respect to the rest of the lever.

According to another aspect of the present invention there is provided a valve coupling system including a coupling according to anyone of the previous embodiments and a valve assembly located in the fluid delivery pipe. coupling for coupling with a fluid delivery outlet.

The inlet coupling may have a tubular housing with an outlet including an outlet flange, an inlet and a valve seat for a valve body of the valve assembly.

It is preferred that the valve assembly includes a first part with an upper end adapted to contact a lower end of the elongate member of the valve actuating means.

The first part lower end may be adapted to abut an upper end of a second part including a valve sealing means which is adapted to form a seal with the valve seat of the inlet coupling.

The first part may include a head section with a concave head portion adapted to receive the bottom end of the elongate member.

It is preferred that the first part includes a base portion which is annular.

The first part preferably includes an interconnecting portion connecting the head portion and base portion.

The second part preferably is tubular.

The second part may include an upper head section.

The second part preferably includes a valve seat member.

The valve seat member is preferably at the lower end of the second part.

The second part may include a lower portion including the valve seat member.

It is preferred that the lower portion is removably detachable from the valve seat member.

The second part preferably includes a central section with peripheral windows.

The first part preferably includes a central section with peripheral windows.

It is preferred that the peripheral windows of the first and second parts allow passage therethrough of fluid.

According to another aspect of the present invention there is provided a valve assembly component having a head portion, a base portion and an interconnecting portion interconnecting the head portion and base portion, the component being adapted to abut an elongate member of a valve spindle at its upper end and abut a top portion of a valve assembly member at its lower end.

The head portion preferably includes a concave upper face.

The interconnecting portion preferably includes a plurality of supports.

The supports are preferably separated by windows.

The base portion may be annular.

According to another aspect of the present invention there is provided a valve assembly member including a tubular body portion having a plurality of peripheral windows and a lower portion having a valve sealing member.

The valve sealing member may be removably attachable to the lower portion.

The top portion is preferably for abutment with a base portion of the valve assembly component.

According to a preferred embodiment of the present invention the coupling is able to be moved 360° so that the outlet faces any desired location.

According to the preferred embodiment the coupling allows a finite control of fluid leaving the outlet of the delivery pipe. This is achieved by turning of the tap fitting.

According to another aspect of the present invention a detent which may be in the form of a grub screw or circlip is provided on an internal surface of the fluid delivery pipe to prevent the upper valve component from being removed from the outlet of the fluid delivery pipe.

It is preferred that the grub screw is located at a position between the head portion and the base portion of the upper valve component.

A preferred embodiment of the present invention will now be described by way of example only with reference to the accompanying drawings in which:

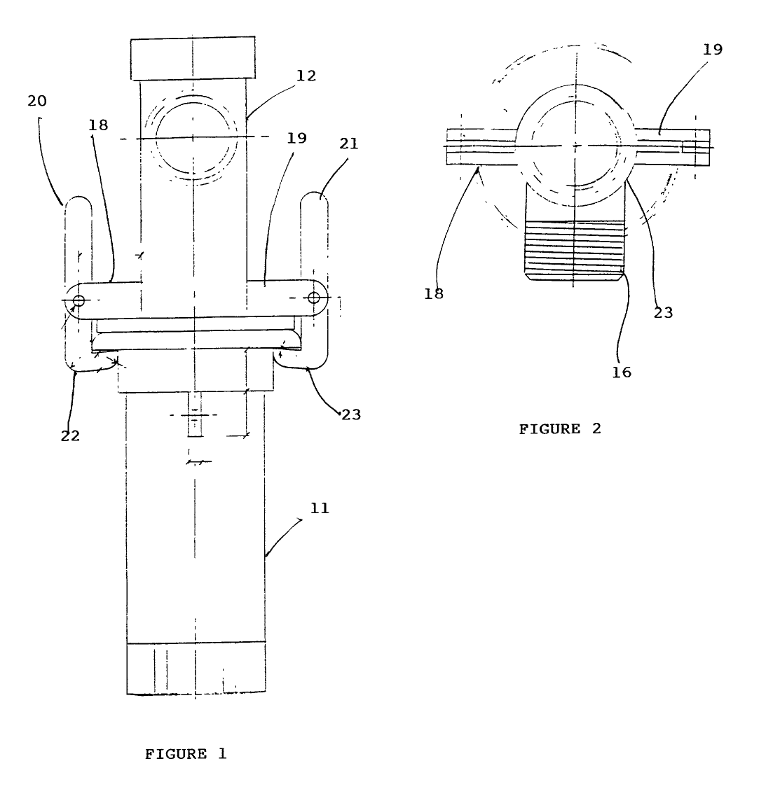

FIG. 1 shows a front view of a valve coupling pipe and a head sprinkler valve according to a first embodiment of the present invention;

FIG. 2 shows a top view of the coupling shown in FIG. 1;

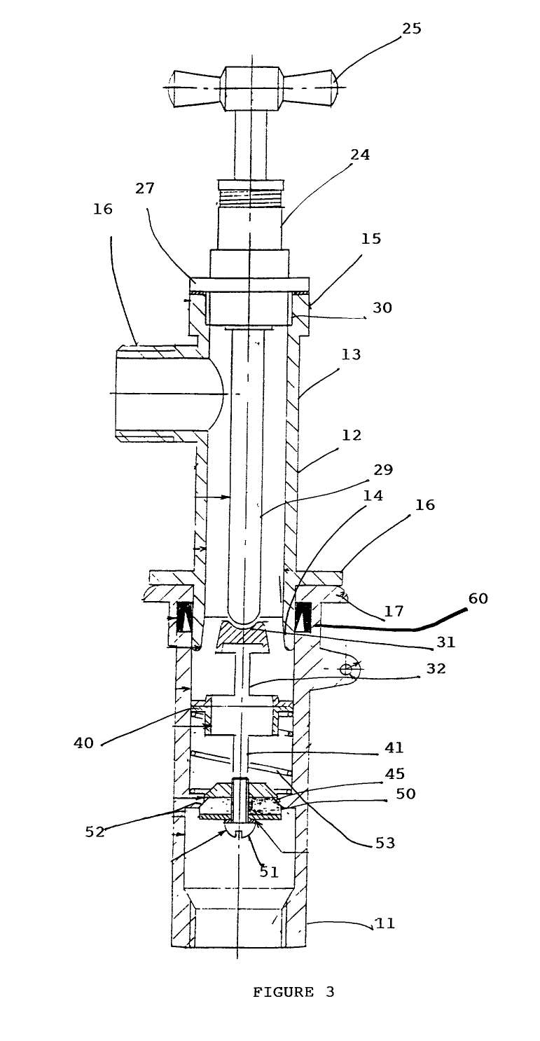

FIG. 3 shows a sectional front view of the coupling and head sprinkler valve shown in FIG. 1;

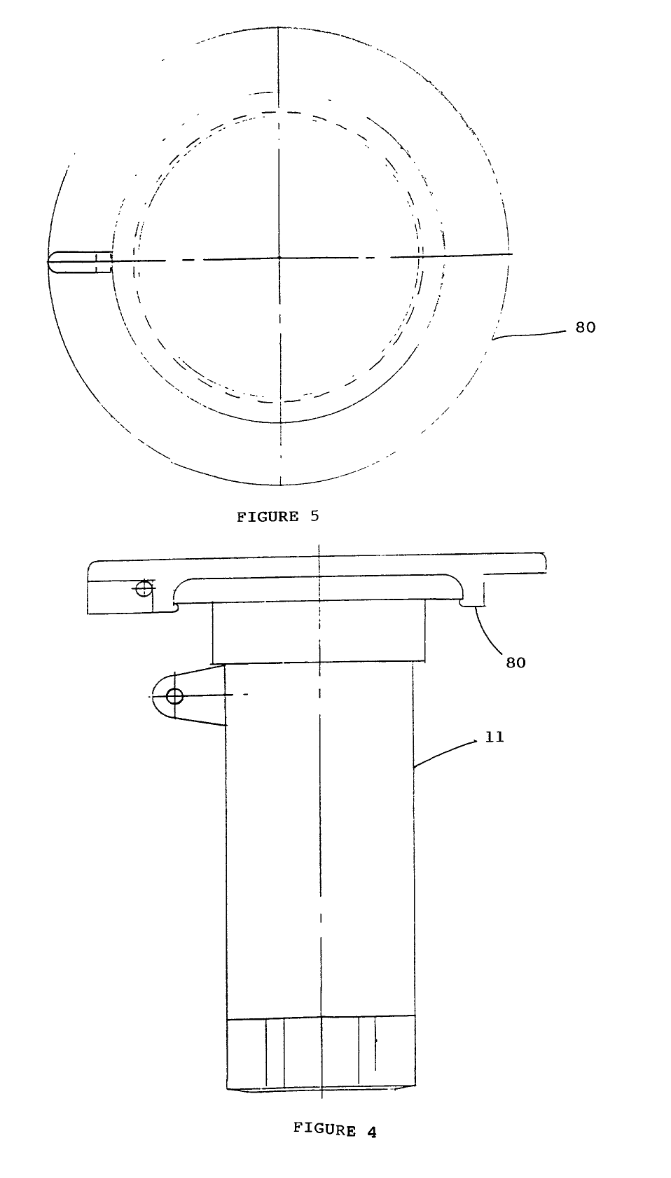

FIG. 4 shows a front view of the head sprinkler valve shown in FIG. 1;

FIG. 5 shows a top view of the head sprinkler valve shown in FIG. 1;

FIG. 6 shows a valve spindle for use with the coupling shown in FIG. 1;

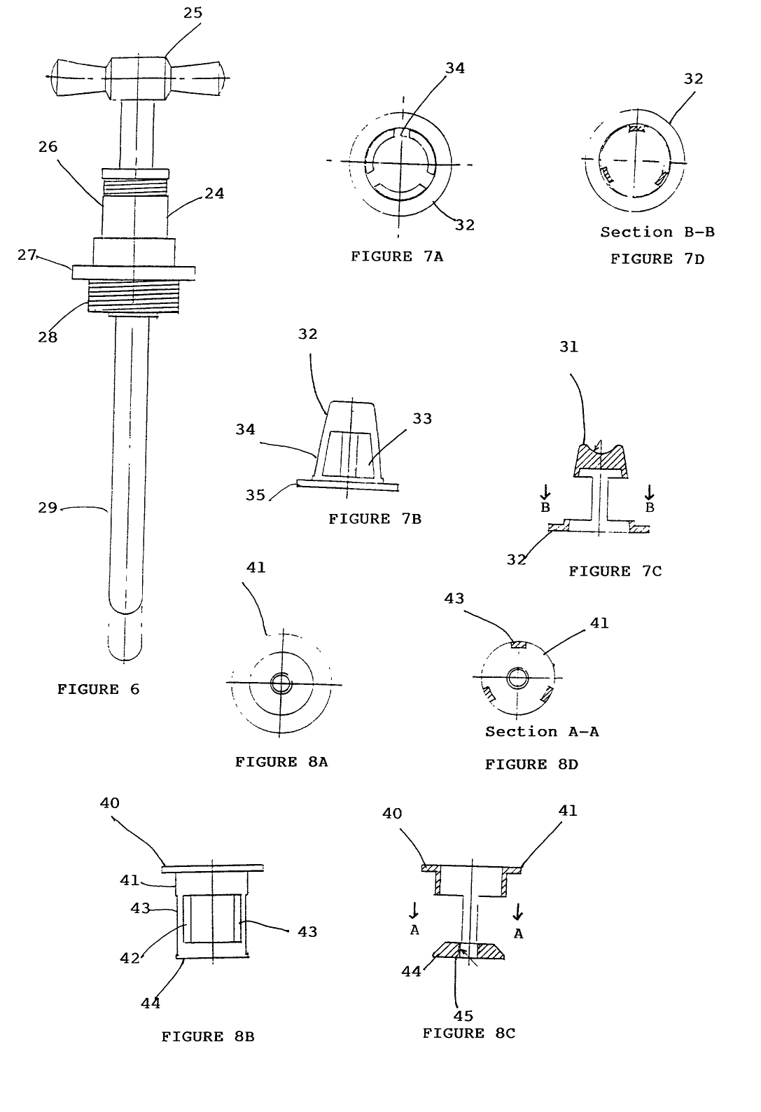

FIG. 7a shows a top view of an upper valve component for use in the head sprinkler valve shown in FIG. 3;

FIG. 7b shows a front view of the upper valve component;

FIG. 7c shows a sectional view of the upper valve component shown in FIG. 7b;

FIG. 7d shows a sectional view B-B of the upper valve component shown in FIG. 7c;

FIG. 8a shows a top view of a lower valve component;

FIG. 8b shows a front view of the lower valve component;

FIG. 8c shows a cross-sectional view of the lower valve component; and

FIG. 8d shows a sectional view A-A of the lower valve component shown in FIG. 8c.

A head sprinkler valve outlet 11 is shown coupled with a sprinkler coupling 12 in FIGS. 1 to 3.

The sprinkler coupling 12 consists of a vertical tubular housing 13 having an inlet 14 at its lower end and a spindle coupling outlet at its upper end 15.

Just below the outlet end 15 a fluid outlet 16 extends horizontally.

The lower end of the housing 12 is provided with a peripheral flange 16 22 mm before the lowermost point of the inlet 14.

With the sprinkler coupling 12 fully inserted into the head sprinkler outlet 11 as shown in FIGS. 1 and 3 the flange 16 abuts a flange outlet 17 of the coupling 11.

Just above the flange 16 the housing 12 is provided with laterally extending arms 18, 19 which are diametrically opposed and each provided with latching levers 20, 21 respectively, but preferably these arms are replaced by lugs.

Each of the latching levers 20, 21 are pivotally connected to the outer end of the arms 18, 19 and at their lower ends are provided with inwardly directed catches 22, 23 respectively. The pivots are preferably located above the edge of lower flange 16 so that the latching levers lock in a vertical orientation. In FIGS. 1 and 3 both catches 22, 23 lock the sprinkler coupling 12 to the head sprinkler outlet 11.

A tap spindle 24 having an upper handle 25, a body section 26 including a mid section flange 27 and lower peripheral thread 28 has a spindle element 29 extending vertically downwardly therefrom.

The tap spindle 24 is adapted to be screwed into the upper outlet 15 which itself has an internal thread 30.

When the spindle 24 is fully screwed into the sprinkler coupling 12 its flange 27 abuts the top surface of the upper outlet 15, at the same time the lowermost end of the spindle element is designed to abut a concave top face 31 of an upper valve component 32 located in the head sprinkler outlet 11. FIGS. 7a to 7d show that this upper valve component 32 is effectively a tubular cap with a frusto conical shape.

The periphery of the component 32 includes three equally spaced peripheral windows 33, each separated by wall elements 34.

The wall elements 34 terminate in a closed head section at the top of the upper valve component 32.

The lowermost part of the upper valve assembly component 32 is provided with an annular planar base 35.

The base 35 is designed to abut an upper face 40 of a lower valve assembly component 41 shown more clearly in FIGS. 8a to 8d.

The lower valve assembly component 41 is also tubular but has a generally cylindrical shape. Like the upper valve assembly component 32 the lower valve assembly component 41 is also provided with three equally spaced windows 42 having a generally square/rectangular shape. Each of these windows are separated by vertical wall elements 43.

The bottom of the lower valve component 41 is closed and thus provided with a base wall 44. This base wall has a central aperture with an internal thread and is adapted to receive a valve seal 50 which is able to be screwed onto the lower face 45 of this base 44.

As shown in FIG. 3 both the upper and lower valve components 32, 41 are adapted to be located in an upper section of the head sprinkler outlet 11. This upper section being above the valve seat 52. A spring 53 is located around the lower valve component 41 and is interposed between the upper flange 40 of the lower valve component 41 and the upper surface of the seat 52.

The maximum diameter of the lower part including the base of the lower valve component 41 is no larger than the width of the passage through the seat 52. However the valve seal 50 naturally has a wider diameter than the seat and is unable to pass through the passage through the seat and is thus retained on the lower side of the seat 52.

In operation without the sprinkler coupling 12 attached to the head sprinkler outlet 11, water pressure closes the valve assembly 32, 41, 50 so that the valve seal rests on the valve seat 52, thus closing the passage through the seat 52. In this position the upper and lower valve components 32, 41 are exposed above the valve seat 52. The lower valve component 41 is fixed in location because it is connected to the valve seal 50 through the screw 51. The upper valve component 32 however is able to be removed if desired.

As shown in FIGS. 5 and 4 without the sprinkler coupling 12 attached to the head sprinkler outlet 11 a rubber cap 80 is placed over the head sprinkler outlet 11.

If it is desired to perform a sprinkling action, for example on a golf course, the rubber cap 80 can be removed and the sprinkler coupling 12 can be inserted into the outlet end of the head sprinkler outlet 11 so that its peripheral flange 16 abuts the outlet 17. The latches 20, 21 can then be pivoted so that the catches 22, 23 engage the underside of the flange 17 of the head sprinkler outlet 11. Thus the sprinkler coupling 12 is fixed to the head sprinkler outlet 11.

A V-seal 60 then provides a watertight connection between the head sprinkler outlet 11 and the sprinkler coupling 12.

By turning the handle 25 of the spindle 24 the spindle element 29 moves downwardly to engage the top face 31 of the upper valve component 32. Further rotation of the handle 25 pushes the upper valve component into contact with the lower valve component 41 which in turn pushes the valve seal 50 downwardly thus removing it from the seat 52. This allows water to flow through the passage inside the outlet 11 and through the upper and lower valve components 32, 41 through their respective windows 33, 42. Water continues upwardly and out through the outlet 16 through a hose and is able to be dispersed in any desired fashion.

Utilising a sprinkler coupling with a head sprinkler outlet and valve components as described above enables water to be delivered from any location where there is a head sprinkler outlet just by connecting the sprinkler coupling 12. It is only necessary to have a single sprinkler coupling 12 because once it has been removed the head sprinkler outlet is closed due to the valve seal 50.

The claims defining the invention are as follows:

1. A coupling for a fluid delivery pipe, the coupling having a housing with an inlet, outlet and interconnecting passage, a valve actuating means including an elongate member which extends to an inlet end of the housing and an external locking means for securing to the coupling the fluid delivery pipe, wherein in use when the coupling is secured to the fluid delivery pipe by the locking means the valve actuating means is operable to force the elongate member into contact with a valve assembly of the fluid delivery pipe to force the valve assembly to open and allow passage of fluid into the inlet and out through the outlet.

2. The coupling as claimed in claim 1 wherein the housing includes a flange portion at its inlet end which flange portion is adapted to abut an outlet flange of the fluid delivery pipe.

3. The coupling as claimed in claim 2, wherein the housing inlet end is adapted to fit inside the outlet end of the fluid delivery pipe.

4. The coupling claimed in claim 3 wherein the housing outlet extends from a side of a main body of the housing.

5. The coupling as claimed in claim 4 wherein the housing includes a tubular main body including an upper end adapted to receive the valve actuating means and a lower end including the inlet.

6. The coupling as claimed in claim 5 wherein the outlet extends at right angles from an upper section of the main body.

7. The coupling as claimed in claim 6 wherein the valve actuating means includes a tap fitting.

8. The coupling as claimed in claim 7 wherein the tap fitting is threadably engaged in the upper end of the main body.

9. The coupling as claimed in claim 8 wherein the elongate member comprises a rod which extends to a region inside the inlet.

10. The coupling as claimed in claim 9 wherein the locking means includes a plurality of latches.

11. The coupling as claimed in claim 10 wherein the latches are diametrically opposed on opposite sides of the main body.

12. The coupling as claimed in claim 11 wherein each latch includes a lever pivotally attached to the lateral member.

13. The coupling as claimed in claim 12 wherein each Lever includes a catch at a lower end, which catch is adapted to catch under the outlet flange of the fluid delivery pipe.

14. The coupling as claimed in claim 1 including a valve assembly comprising a first part with an upper end adapted to contact a lower end of the elongate member of the valve actuating means.

15. The coupling as claimed in claim 14 wherein a lower end of the first part is adapted to abut an upper end of a second part of the valve assembly, the second part including a valve sealing means which is adapted to form a seal with a valve seat of an inlet coupling to which the coupling is adapted to be connected.

16. A coupling as claimed in claim 15 wherein the first part includes a head section with a concave head portion adapted to receive the bottom end of the elongate member.

17. The coupling as claimed in claim 15 wherein the First part includes a base portion which is annular and an interconnecting portion connecting the head portion and the base portion.

18. The coupling as claimed in claim 17 wherein the second part includes an upper head section and a valve seat member at a lower end thereof.

19. The coupling as claimed in claim 18 wherein the second part includes a lower portion including the valve seat member.

20. The coupling as claimed in claim 19 wherein the lower portion is removably detachable from the valve seat member.

21. The coupling as claimed in claim 20 wherein the second part includes a central section with peripheral windows which allow passage therethrough of fluid.

22. The coupling as claimed in claim 21 wherein the first part includes a central section with peripheral windows adapted to allow passage therethrough of fluid.

23. A valve assembly component for use with a coupling for a fluid delivery pipe, the coupling having a housing with an inlet, outlet and interconnecting passage, a valve actuating means including an elongate member which extends to an inlet end of the housing and an external locking means for securing the coupling to the fluid delivery pipe, the valve assembly component being adapted to be placed in a fluid delivery pipe inlet coupling and having a head portion, a base portion and an interconnecting portion interconnecting the head portion and base portion, the component being adapted to abut an elongate member of a valve spindle at its upper end and abut a top portion of a valve assembly member at is lower end.

24. The valve assembly component as claimed in claim 23 wherein the head portion includes a concave upper face.

25. The valve assembly component as claimed in claim 26 wherein the interconnecting portion includes a plurality of supports separated by windows.

26. A valve assembly adapted for use with a coupling having a housing with an inlet, outlet and interconnecting passage, a valve actuating means including an elongate member which extends to an inlet end of the housing and an external locking means for securing the coupling to a fluid delivery pipe, the valve assembly being adapted for location in the fluid delivery pipe and comprising a valve assembly component having a head portion, a base portion and an interconnecting portion interconnecting the head portion and base portion and a valve assembly member including a tubular body portion having a plurality of peripheral windows and a lower portion having a valve sealing member, the valve assembly component being adapted to abut the elongate member of the valve spindle at its upper end and abut a top portion of the tubular body portion of the valve assembly member at its lower end.

27. The valve assembly as claimed in claim 26 wherein the valve sealing member is removably attachable to the lower portion.

28. The valve assembly as claimed in claim 27 including an urging means for urging the lower portion away from sealing contact with a valve seat of the discharge pipe.

29. A coupling substantially as hereinbefore described With reference to the accompanying drawings.

30. A valve assembly substantially as hereinbefore described with reference to the accompanying drawings.
